(19) United States
(12) Patent Application Publication
(10) Pub. No.: US 2024/0082882 A1
(43) Pub. Date: Mar. 14, 2024

(54) TOOL FOR REMOVING HAIR FROM BAR SOAP

(71) Applicant: Frederick Matthew Thyng, Kittery Point, ME (US)

(72) Inventor: Frederick Matthew Thyng, Kittery Point, ME (US)

(21) Appl. No.: 18/458,481

(22) Filed: Aug. 30, 2023

Related U.S. Application Data
(60) Provisional application No. 63/374,945, filed on Sep. 8, 2022.

(51) Int. Cl. B08B 1/00; A47K 17/00; B25G 1/10

(52) U.S. Cl. CPC B08B 1/005; A47K 17/00; B25G 1/102

(57) ABSTRACT

A hand held tool enabling a user to remove hair from a bar of soap, by providing a row of tines attached to one end of a handle, oriented perpendicular and pointed down at an obtuse angle to that handle, for optimal dragging along the surface of a bar of soap, in order to collect and remove unwanted hair in an efficient, safe, and resourceful manner, as a means to encourage social common courtesy and improve basic hygiene practices.

### BACKGROUND INFORMATION

### Field of the Invention

The invention relates to products and activities associated with washing of the human body, including bathing and showering.

### Discussion of Prior Art

During washing activities, such as bathing and showering, it is very common for loose hair from the human body to collect on a bar of soap used in the cleaning process. These loose hairs often originate from various parts of the body including the head, face, chest, back, underarms, arms, hands, buttocks, genitalia, legs, and feet.

The tacky texture of a bar of soap, particularly when wet, causes loose hairs to stick to its surface. Removal of hair from a bar of soap is generally first attempted by placing the bar under running water, by rubbing the bar with hands, or a combination of both. It is also very common, however, for hair to become embedded into the bar of soap requiring a more aggressive approach of physical removal. This approach usually involves dragging a fingernail across the surface of the bar of soap in an attempt to snag the hair and drag it off the bar. Removal of each individual hair, which can range greatly in length, diameter, shape, and texture, from a bar of soap can be extremely frustrating and time consuming. This is especially true for certain individuals, with some examples being those who have issues with: dexterity, poor eyesight, thick fingers, or short fingernails. This primitive approach is not only time consuming, but also wasteful, considering the amount of soap that is washed away and wasted during the process.

A single bar of soap is often used by more than one individual and is commonly shared within groups, such as a family household. In general, it is considered cordial and proper to remove hair from a bar of soap after each use, prior to leaving it for the next user. Of particular concern is the presence of pubic hair left behind on a bar of soap by a previous user. Not only is this practice widely frowned upon as lazy and offensive, but it also creates an unsanitary condition, ironically in an environment that is reserved for cleaning the body. In situations where the bar of soap is not shared, it is still commonplace for the physical washing location to be shared, such as a bathroom. In this situation, a bar of soap left in plain sight for others to view can be disturbing when unsightly hair is present.

What is needed, therefore, is a tool which removes hair from a bar of soap in an efficient, safe, and resourceful manner to encourage social common courtesy and improve basic hygiene practices.

### BRIEF SUMMARY OF THE INVENTION

The invention is a tool for removing hair from a bar of soap. The tool is equipped with a handle which is intended to be held in one hand. Attached to one end of the handle is a perpendicular row of tines. These tines are strategically angled down and away from the handle in an orientation optimal for dragging along a surface. The obtuse angle of the tines in relation to the handle allows for smooth dragging of the tips along the soft surface of the bar of soap in the direction of the handle. The tines are aligned in such a manner that is conducive to the collection of hair when pulled across a bar of soap.

Tool operation involves holding a bar of soap in one hand, gripping the tool in the other, and dragging the tips of the tines across the surface of the bar of soap in the direction of the tool's handle to collect and remove the unwanted hair.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is an iso perspective view of the topside of the tool.

FIG. 2 is an iso perspective view of the underside of the tool.

FIG. 3 is a standard perspective view of the topside of the tool.

FIG. 4 is a standard perspective view of the underside of the tool.

FIG. 5 is a standard perspective view of the side of the tool.

FIG. 6 is an iso perspective view of the underside of the tool showing an example of typical use with a bar of soap.

FIG. 7 is an iso perspective view of the topside of the tool showing an example of typical use with a bar of soap.

### DETAILED DESCRIPTION OF THE INVENTION

The present invention will now be described more fully in detail with reference to the accompanying drawings to fully convey the scope of the invention to those skilled in the art.

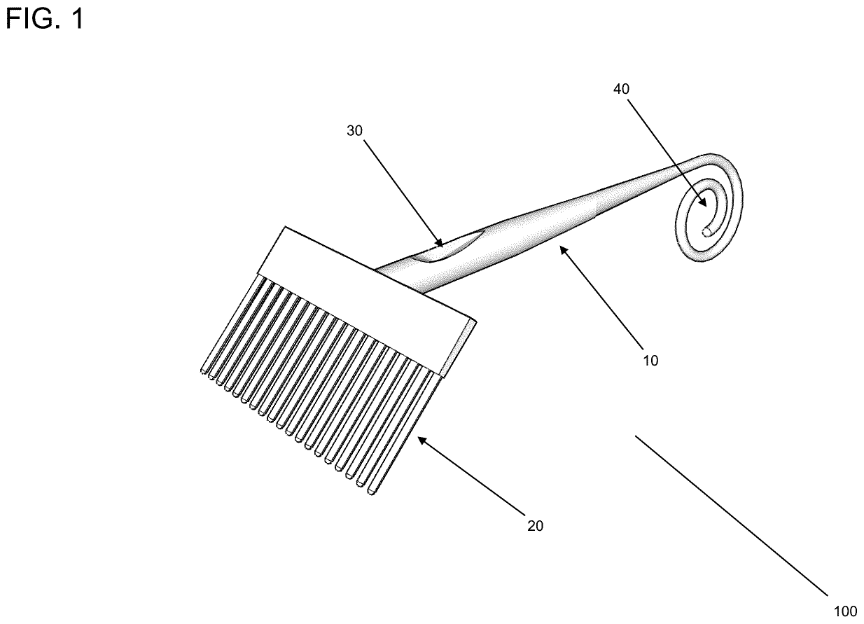

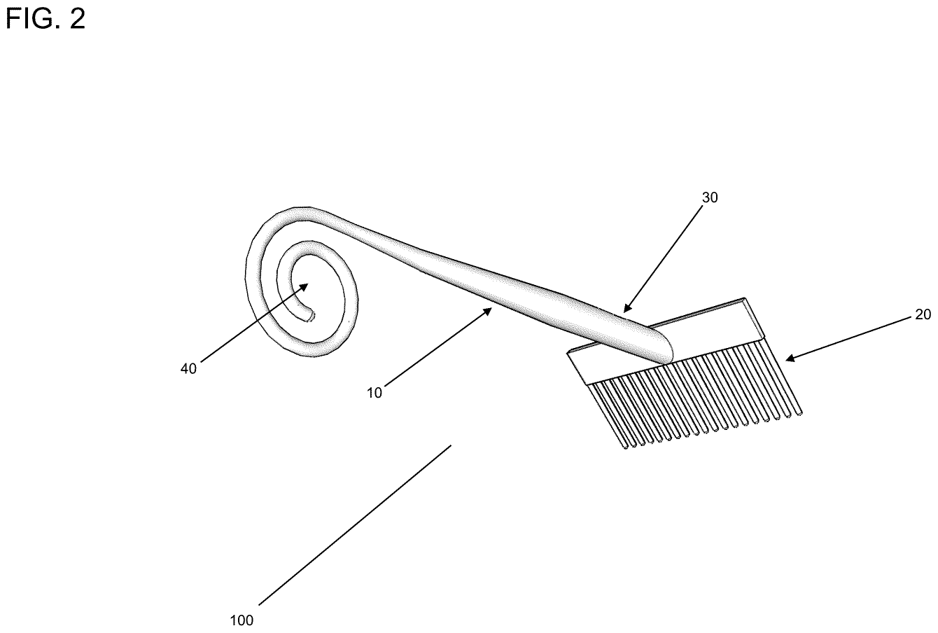

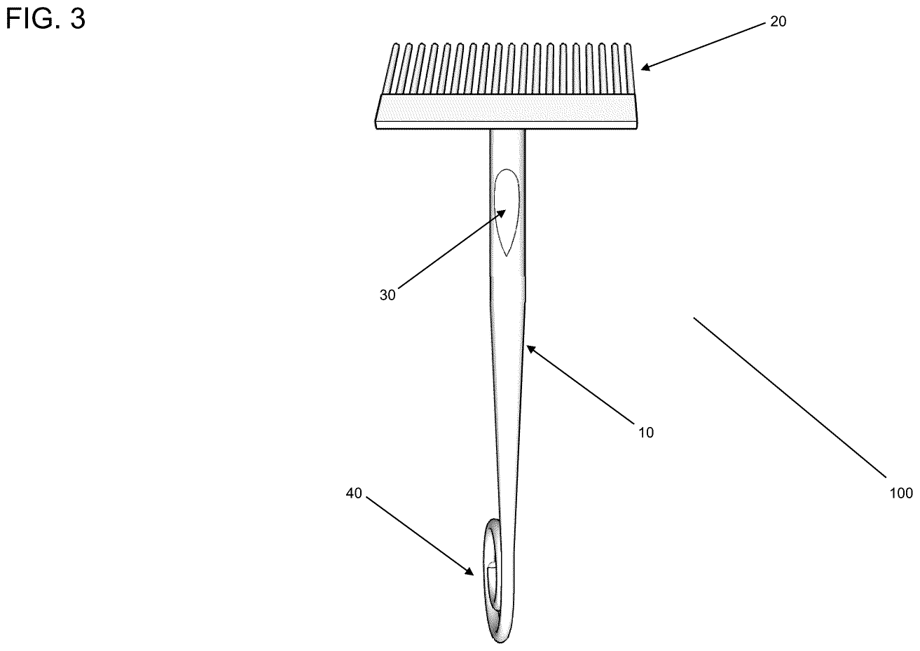

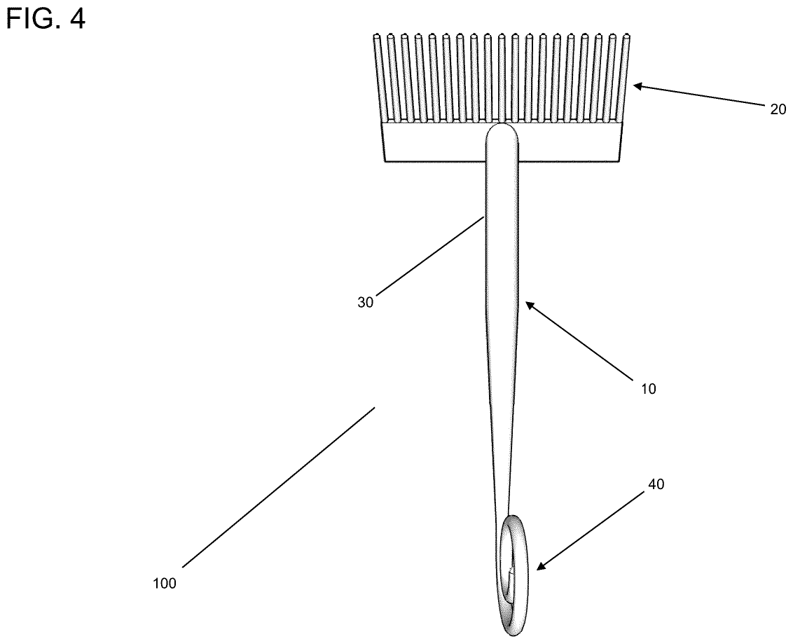

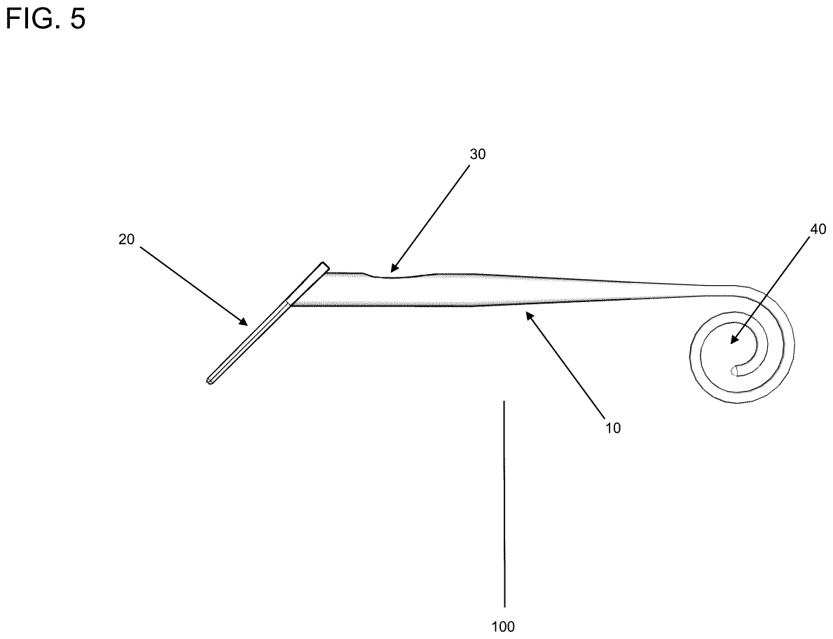

FIGS. 1-5 illustrate a tool 100 used for the removal of hair from a bar of soap. The tool 100 includes a handle 10, a row of tines 20, a thumb grip 30, and a curled end 40.

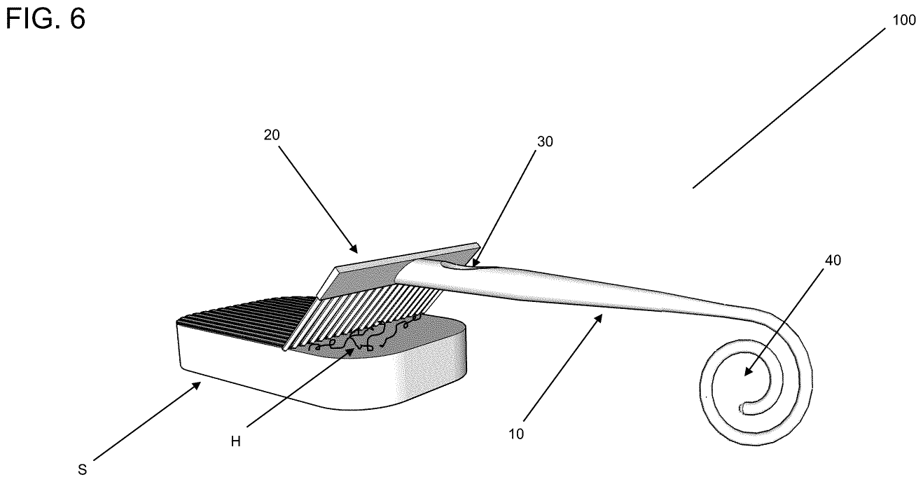

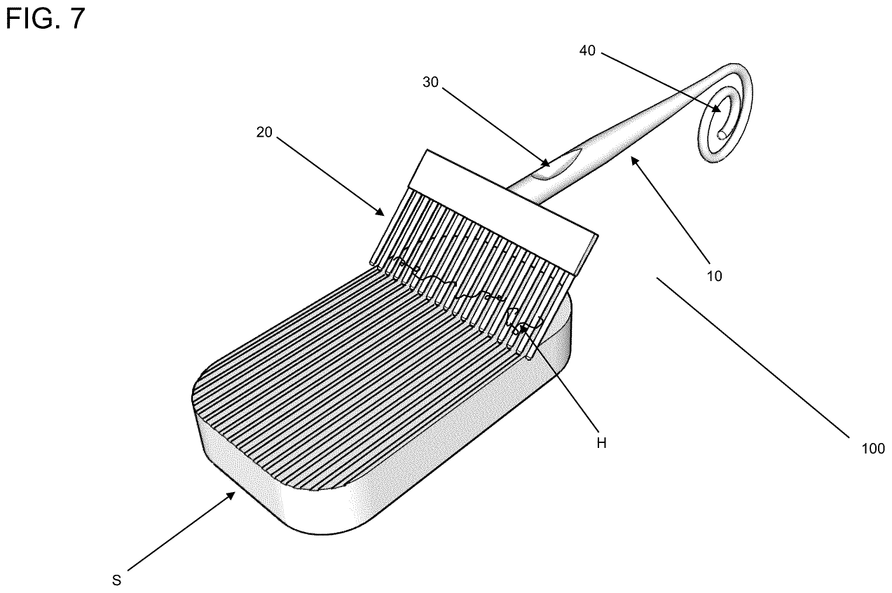

FIGS. 6-7 show examples of typical use of the tool 100 on a bar of soap S.

Operation of the tool 100 is performed by holding the tool 100 in one hand by the handle 10. Added control of the tool 100 is provided via the thumb grip 30. The tips of the tines 20 are placed on the surface of bar of soap S and are dragged across bar of soap S in the direction of the handle 10, towards the hair H to be removed. The obtuse angle of the tines 20 in relation to the handle 10 provides optimal positioning of the tines 20 for dragging and collecting hair H. Hair H located in the path of the tines 20 are caught up in the tines 20 and dragged across the surface of bar of soap S.

Hair H collected in the tines 20 is removed and discarded and the tool 100 can be cleaned by rinsing under running water. The tool 100 can be placed on a wall mounted holder using the curled end 40 at the end of the handle 10. This allows for convenient access in most conventional washing environments.

It is understood that the embodiments described herein are merely illustrative of the present invention. Variations in the construction may be contemplated by one skilled in the art without limiting the intended scope of the invention herein disclosed and as defined by the following claims.

What is claimed is:

1. A tool to assist a user in removing hair from a bar of soap, the tool comprising:
a handle,
a row of tines attached to the handle, wherein the row of tines are:
located at one end of the handle;
oriented perpendicular to the handle;
pointed down in relation to the intended position of the handle when being held; and,
oriented at an obtuse angle to the handle in relation to the intended position of the handle when being held.

2. A tool as in claim 1, wherein the handle is constructed out of a rigid material.

3. A tool as in claim 2, wherein the end of the handle opposite the row of tines is in the shape of a curl.

4. A tool as in claim 2, wherein the handle is equipped with a thumb grip.
